(19) United States
(12) Patent Application Publication
(10) Pub. No.: US 2016/0217056 A1
(43) Pub. Date: Jul. 28, 2016

(54) DETECTING FLOW ANOMALIES

(71) Applicant: HEWLETT-PACKARD DEVELOPMENT COMPANY, L.P., HOUSTON, TX (US)

(72) Inventors: FREDDY CHUA, Palo Alto, CA (US); Bernardo Huberman, Palo Alto, CA (US); Ee-Peng Lim, Singapore (SG)

(21) Appl. No.: 14/607,247

(22) Filed: Jan. 28, 2015

(51) Int. Cl. G06F 11/34

(52) U.S. Cl. CPC G06F 11/3447; G06F 11/3452

(57) ABSTRACT

An example method can include receiving network data related to a distributed system. A statistical model of the distributed system based on the network data can be employed to determine a statistical deviation of a given flow of information through a portion of the distributed system. A number of statistically deviated flows connected to the given flow can be determined based on a context of the distributed system. A determination can be made if the given flow is an anomaly based on the number of statistically deviated flows connected to the given flow.

### BACKGROUND

As the world become increasingly complex, networks offer an abstract representation for organizing the relationships between entities of interest in distributed systems. The entities are represented as nodes, while edges connecting pairs of nodes represent the existence of relationships between the entities. In these distributed systems, a functional network that facilitates reliable and consistent flow of entities through the edges is necessary for the distributed system to achieve its objectives. The building blocks of the distributed systems can deteriorate non-uniformly over time, leading to occasional anomalous behavior in certain parts of the system.

### BRIEF DESCRIPTION OF THE DRAWINGS

FIG. 1 illustrates an example of an anomaly detection system to detect anomalies that lay hidden in a distributed system.

FIG. 2 illustrates an example of a path that can have an anomaly.

FIG. 3 illustrates an example of an inference of a time to complete elements of a path.

FIG. 4 illustrates an example of an anomaly discovered within a path.

FIG. 5 illustrates a flowchart of an example method for detecting anomalies that lay hidden in a distributed system.

FIG. 6 illustrates a flowchart of another example method for detecting anomalies that lay hidden in a distributed system.

FIG. 7 illustrates a flowchart of an example method for employing a statistical model of the network.

FIG. 8 illustrates a flowchart of an example method for determining if a flow is an anomaly.

FIG. 9 illustrates another example of an anomaly detection system.

### DETAILED DESCRIPTION

Anomalies in a distributed system can disrupt normal operations and prevent the distributed system from meeting its objectives in a timely manner. Some anomalies are critical anomalies, which lead to catastrophic failures and cause major disruptions to a distributed system. Accordingly, critical anomalies are highly noticeable by the stakeholders of the distributed system and are thus quickly identified and localized for corrections to restore the functions of the distributed system. Other anomalies are non-critical anomalies, which may result in a lower than optimal efficiency of a distributed system. Since the distributed system can continue to function without corrections to these non-critical anomalies, these non-critical anomalies are often ignored and its location unknown within the distributed systems. However, non-critical anomalies that are ignored and not corrected could aggravate over time into critical anomalies and cause catastrophic failures to the distributed systems in the unforeseeable future.

Accordingly, the systems and methods described herein aim to recognize the non-critical anomalies in a distributed systems. An example anomaly detection system can include a non-transitory memory to store machine readable instructions and a processing resource (e.g., one or more processor cores) to execute the machine readable instructions. A receiver can receive network data. A statistical model component that employs a statistical model of the network based on the network data to determine a statistical deviation of a flow. A statistically deviated flow component can discover a number of statistically deviated flows connected to the flow. An output can specify a location and a strength of an anomaly in the distributed system.

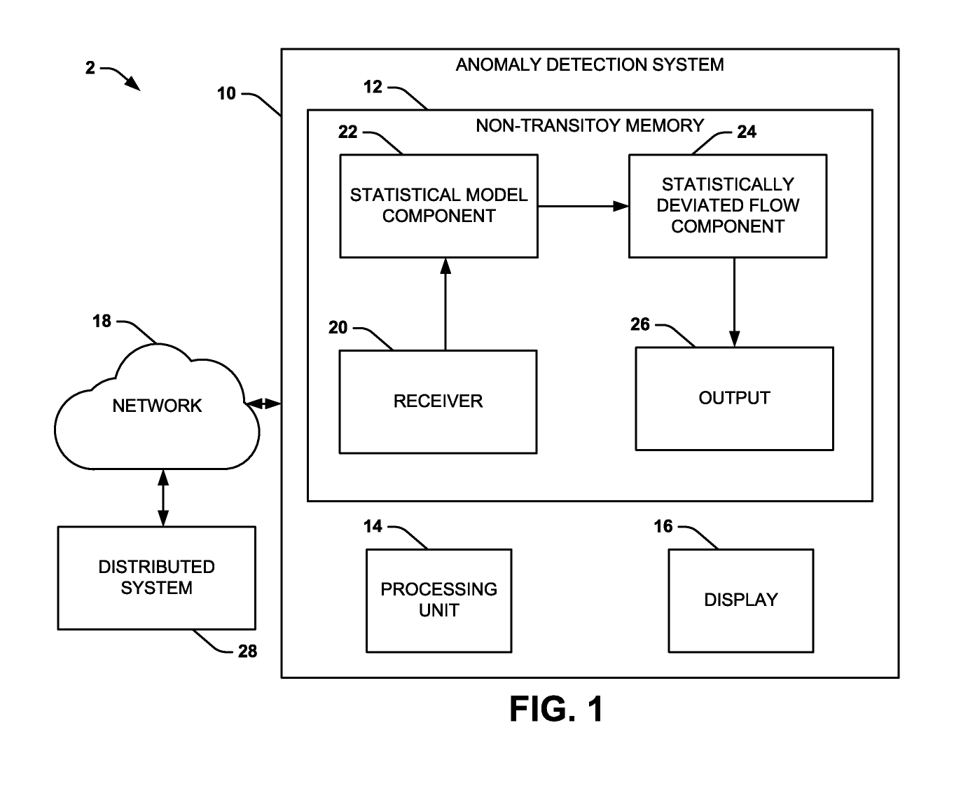

FIG. 1 illustrates an example of an anomaly detection system 10 that can detect anomalies that lay hidden in a distributed system 28. As used herein, the term “distributed system” can refer to a plurality of entities (represented as nodes) where relationships between the pairs of entities are represented as edges connecting pairs of nodes. In some examples, the nodes are physical nodes (e.g., servers, computers, etc.). In other examples, the nodes can be virtual nodes (e.g., virtual machines). In still other examples, the nodes can include both physical nodes and virtual nodes. Accordingly, the distributed system has at least two nodes and at least one edge. Examples of distributed systems can include social networks, protein networks, computer networks, transportation networks, logistical networks, neurological networks, organizational networks, wireless sensor networks, electrical networks, and the like. As used herein, the term “anomaly” can refer to a condition of the distributed system that can disrupt normal operations of the distributed system and prevent the distributed system from meeting its objectives in a timely manner. For example, the anomaly can be a critical anomaly and/or a non-critical anomaly.

As an example, the anomaly detection system 10 can detect an anomaly in the distributed system 28 in a non-intrusive manner. A network 18 can connect the distributed system 28 and the anomaly detection system 10. The network 18 can include wired connections and/or wireless connections. In some examples, the anomaly detection system 10 can be part of the distributed system 28. In other examples, the anomaly detection system 10 can be external to the distributed system 28. For example, the anomaly detection system 10 can be executed by a server or other computing device.

The anomaly detection system 10 can include a non-transitory memory 12 to store machine-executable instructions. Examples of the non-transitory memory 12 can include volatile memory (e.g., RAM), nonvolatile memory (e.g., a hard disk, a flash memory, a solid state drive, or the like), or a combination of both. The anomaly detection system 10 can include a processing unit 14 (e.g., one or more processing cores) to access the non-transitory memory 12 and execute the machine-executable instructions to implement functions of the anomaly detection system 10 (e.g., to detect an anomaly in the distributed system 28). In some examples, the anomaly detection system 10 can also include a display 16 (e.g., a monitor, a screen, a graphical user interface, speakers, etc.) that can illustrate the anomaly in the distributed system 28 in a user-perceivable manner. In some examples, although not illustrated, the anomaly detection system 10 can also include a user interface that can include a user input device (e.g., keyboard, mouse, microphone, etc.). The anomaly detection system 10 can be coupled to the network 18 to exchange data with the distributed system 28 via a transceiver (Tx/Rx) (not illustrated). In some examples, the transceiver can send a request for information to one or more components of the distributed system 28 and/or an external component coupled to the network including information for nodes of interest in the distributed system 28 for further processing by the anomaly detection system 10. The transceiver can receive the information over the network 18. In some instances, the information can include the information for the nodes of interest in the distributed system 28.

The anomaly detection system 10 can include a receiver to receive network data related to the distributed system 28. The network data can include the information received over the network 18 requested by the transceiver. For example, the receiver 20 can perform preprocessing of the information received over the network 18. In some examples, the network data can include source points and end points of a plurality of flows in the distributed system. In other examples, the network data can include times associated with a portion of the flows.

The anomaly detection system 10 can also include a statistical model component 22 that can employ a statistical model of the network based on the network data. For example, the statistical model component 22 can determine a statistical deviation of a flow of the plurality of flows. The statistical model component 22 can apply a statistical model that can use all the available information in the data with assumptions from domain and contextual knowledge of the flow to infer the missing information during the flow. Using the statistical model, the information that should be observed at the destination of the flow can be estimated in terms of its mean and variance. By comparing the observation with the estimation (mean and variance), it can reveal whether a flow is statistically deviated or not.

The anomaly detection system 10 can also include a statistically deviated flow component 24 that can, for each flow in the data, discover a number of statistically deviated flows from the plurality of flows connected to the flow. The determination can be based on a time and a location related to each statistically deviated flow. The statistically deviated flow component 24 can address the insufficiency of statistical deviations as sole indicators of anomalies by finding relations between flows (e.g., by examining flows connected to a flow). In other words, in addition to the statistical deviation of each flow, for each flow a number of statistically deviated flows connected to the flow can be derived. The derivation depends on the context and nature of the distributed system. For example, the relation can be defined in terms of the time and the physical location of the flow. An indication of whether the flow is an anomaly can be obtained by positively correlating to the number of statistically deviated flows that are related to the flow. Using the end (source and destination) points of an anomalous flow, the physical location of the anomaly within the distributed system can be isolated.

The anomaly detection system 10 can also include an output 26 that can output the location and strength of the anomalies in the distributed system can be output. For example, the strength of the anomalies can be a quantification (e.g., a number of standard deviations from a mean) of an amount of disruption caused to the network by the anomalies with respect to the other anomalies. As one example, the output can include a plurality of flows with the associated location and strength of the anomaly for each of the plurality of flows. As another example, the output can include a single flow with the associated location and strength of the anomaly for the flow. In either example, the output can be displayed (e.g., by display 16 or on another computing device) so that further actions can be undertaken.

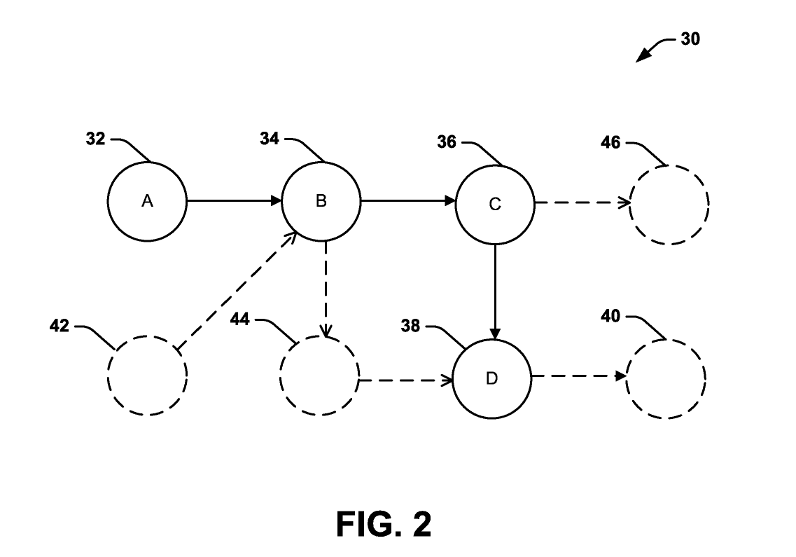

FIG. 2 illustrates an example of a distributed system 30. The distributed system 30 can include a plurality of nodes 32-46, connected by a plurality of edges. One example path of interest travels from A 32 to B 34 to C 36 to D 38. In this example, A 32 is the source point of the flow and D 38 is the end point of the flow.

The anomaly detection system 10 of FIG. 1 can detect the anomaly between B and C in a non-intrusive manner, relying on temporal data related to the flow of entities from the source node A to the destination node D. Accordingly, the anomaly can be detected with only information from the two end points, while assuming that the detailed knowledge of the flow through the intermediate nodes of the path (B 34 and C 36) is missing or difficult to obtain. The problem can be defined based on the assumption that the following record data R of the distributed system is available for analysis. That is, given a set if records R, each record r within R contains the following:
1. Spatial: The source node (A) and the destination node (D) of the flow in r.
2. Temporal: The time t(A) when the entity flow starts at the source node (A) and the time t(D) when the flow ends at the destination node (D).
3. Cost: The distance dr from A to D traveled by the entity, or the non-temporal cost incurred due to the flow. (optional)
4. The path pr taken by r. The path consists of the sequence of nodes that the entity visits for it to flow from node A to node D. In situations where complete knowledge of the network or path is not known, it would still be possible to infer the path based on the distance traveled.
   A pair of consecutive nodes (e.g., B and C) in the path pr can form a segment sij. The anomaly detection system 10 of FIG. 1 can determine whether the observed amount of time taken for the entity flow in pr deviates significantly from the expected amount of time for the entity flow. For all records r within R with observed time that deviates significantly from the expected time, the segments sij within the path that are likely to be the cause of the deviations. This task can be challenging because of the lack of knowledge of the time it takes for entities to flow through the individual segments of the path pr. The expected time for each segment can be inferred based on the set of available records (e.g., within the received network data).

For example, the statistical model component 22 of the anomaly detection system of FIG. 1 can determine which recorded entity flow r is anomaly based on the observed time taken to complete the distance deviates significantly from the expected value determined from a statistical model. In some instances, the deviation can be determined based on a standard deviation. In other instances, the deviation can be determined based on a degree of deviation. Accordingly, the statistical model component 22 of anomaly detection system 10 of FIG. 1 can employ a network transmission model that can perform the inference on spatial-temporal data where knowledge of the temporal trajectory is missing or not available (e.g., in a computer network, the application layer only has knowledge of the two endpoints and does not know the behavior of intermediate nodes).

Building on the network transmission model, the statistically deviated flow component 24 of anomaly detection system 10 of FIG. 1 can also include an algorithm that ranks the anomalous data in order of importance be measuring how much impact each anomalous data has on the others. Based on the impact, the anomalies can be ranked. Using the ranking, the output 26 of the anomaly detection system 10 can output the location where the anomalies occur in the distributed system. In some examples, the output 26 can output the locations in descending order of importance.

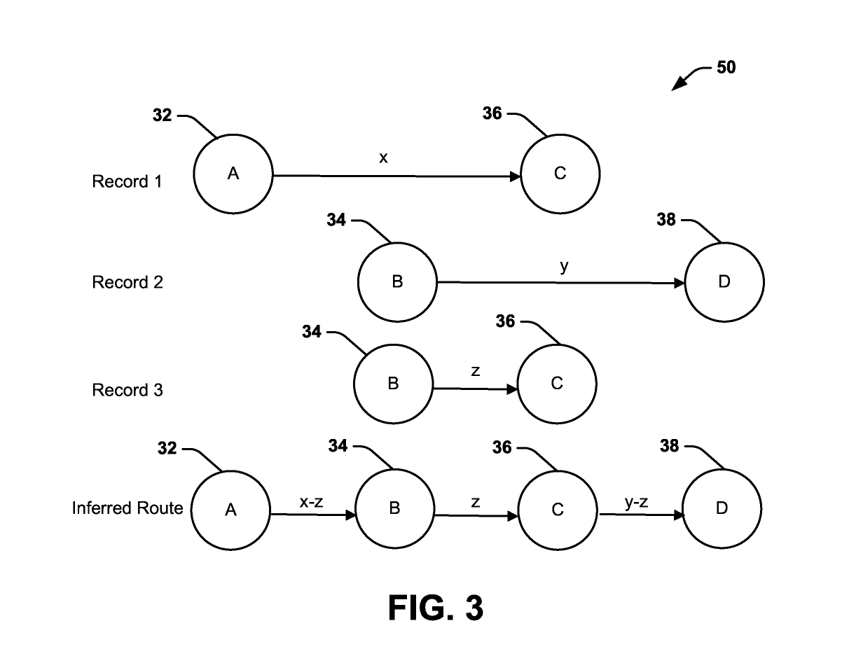

FIG. 3 illustrates an example of an inference 50 of a time to complete elements of a path. For example, the network data can include three Records (1, 2, 3). Record 1 can include a time traveled from A 32 to C 36. As illustrated, the time can be x. Record 2 can include a time traveled from B 34 to D 28. As illustrated, the time can be y. Record 3 can include a time traveled from B 34 to C 36. As illustrated, the time can be z. By using the three Records (1, 2, 3), the time to travel the entire path (A to D) can be constructed. As shown, the inferred route (A to D) can be inferred to take the time x+y−z.

For example, an edge-based network transmission model can be used to infer the flow speeds of the edges within the networks of distributed systems. With the model, the expected time necessary for an entity to complete its flow can be determined. The localization algorithm can be applied to measure the relationship of each record to all other records with large deviations. For example, a record can be deemed anomalous by comparing the difference between the observed time and the expected time with the standard deviation (e.g., measuring the degree of deviation). In some examples, a value (e.g., one or more standard deviations) may be selected as a cut-off to determine whether the path has a significantly larger observed time than expected. The number of related records can allow the exact path taken by the entity flow to be known or easily inferred.

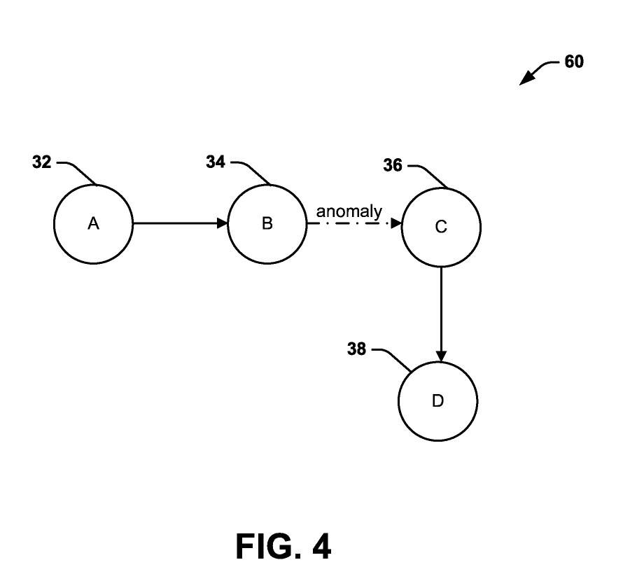

FIG. 4 illustrates an example 60 of an anomaly discovered within a path (e.g., between B and C). The relatedness of two records can be defined using definitions for “contains” and “within. The definition for “contains” includes the satisfaction of the following conditions:
1. The path connecting the source (xr′) and the destination (yr′) of the path (r′) passes through all the nodes of path pr that connects the source (A) and the destination (D) of path r.
2. The time when r′ starts at origin xr′ is earlier than the time when r starts at the origin (A).
3. The time when r′ ends at the destination yr′ is later than the time when r ends at the destination (D).
   Accordingly, r is within r′ if and only if r′ contains r. Based on these two definitions, the example algorithm for localizing the anomalies in the network proceeds as follows:
1. Obtain the set of records such that with the degree of deviation greater than a predetermined cut-off value.
2. For each record r, obtain the set of records that contains r. The value of the absolute value of Rr has a positive correlation on the importance of path pr to other records and traffic.
3. By sorting the set of records in descending value of the absolute value of R and examining the segments sij of path pr, the segments with severe network congestion can be isolated between the times of t(xr) and t(yr).
4. For any given r′, the congested segments of path pr′ can be located by using the path pr of record r, where r is within r′ and Rr is not=0.

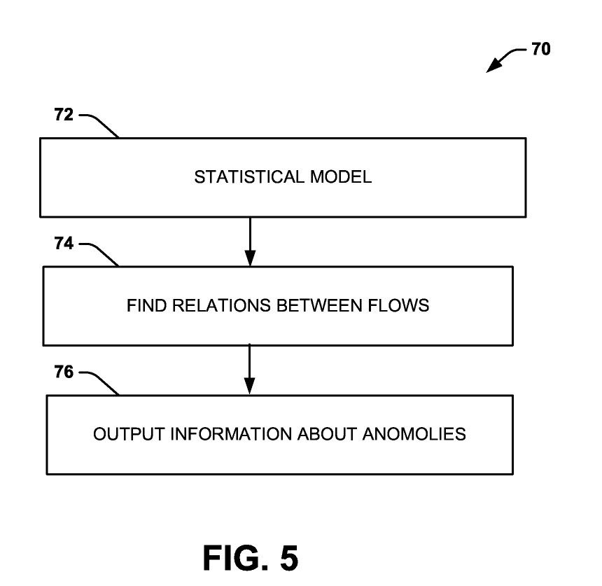

In view of the foregoing structural and functional features described above, example methods will be better appreciated with reference to FIGS. 5-8. While, for the purposes of simplicity of explanation, the example methods of FIGS. 5-8 are shown and described as executing serially, the present examples are not limited by the illustrated order, as some actions could in other examples occur in different orders and/or concurrently from that shown and described herein. Moreover, it is not necessary that all described actions be performed to implement a method. The method can be stored in one or more non-transitory computer readable media and executed by one or more processing resources, such as disclosed herein.

FIG. 5 illustrates a flowchart of an example method 70 for detecting anomalies that lay hidden in a distributed system. For example, the method 70 can be executed by a system (e.g., anomaly detection system 10) that can include a non-transitory memory (e.g., non-transitory memory 12) that stores machine executable instructions and a processing resource (e.g., processing unit 14) to access the memory and execute the instructions to cause a computing device to perform the acts of method 70.

The method 70 can include two phases. The first phase, at 72, can include a statistical model (e.g., applied by statistical model component). The statistical model can use all the available information in the data with assumptions from domain and contextual knowledge of the flow to infer the missing information during the flow. Using the statistical model, the information that should be observed at the destination of the flow can be estimated in terms of its mean and variance, for example. By comparing the actual observation with the estimation (mean and variance), it can reveal whether a flow is statistically deviated or not.

The second phase, at 74, can address (e.g., by statistically deviated flow component 24) the insufficiency of statistical deviations as sole indicators of anomalies by finding relations between flows (e.g., by examining flows connected to a flow). In other words, in addition to the statistical deviation of each flow, for each flow a number of statistically deviated flows connected to the flow can be derived. The derivation depends on the context and nature of the distributed system. For example, the relation can be defined in terms of the time and the physical location of the flow. An indication of whether the flow is an anomaly can be obtained by positively correlating to the number of statistically deviated flows that are related to the flow. Using the end (source and destination) points of an anomalous flow, the physical location of the anomaly within the distributed system can be isolated. At 76, information about the physical location of the anomaly and/or the strength of the anomaly may be output (e.g., by output 26).

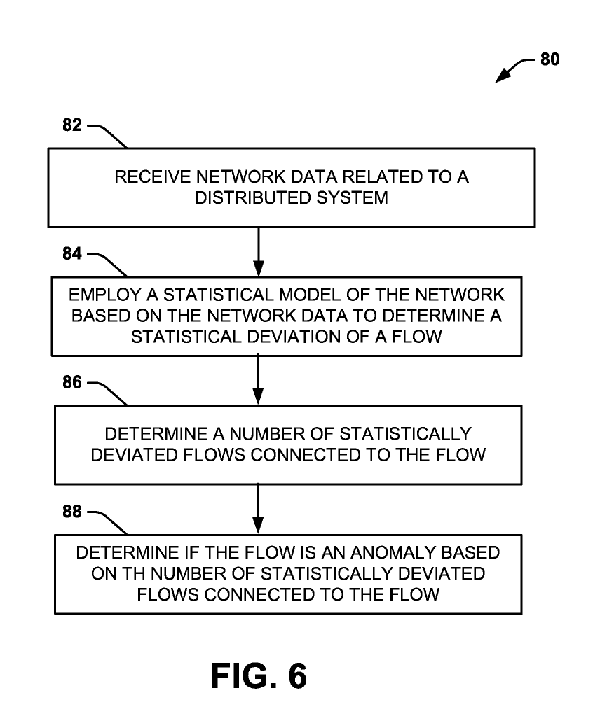

FIG. 6 illustrates a flowchart of an example method 80 for detecting anomalies that lay hidden in a distributed system. For example, the method 80 can be executed by a system (e.g., anomaly detection system 10) that can include a non-transitory memory (e.g., non-transitory memory 12) that stores machine executable instructions and a processing resource (e.g., processing unit 14) to access the memory and execute the instructions to cause a computing device to perform the acts of method 80. At 82, network data related to a distributed system can be received (e.g., by receiver 20). For example, the network data can include source points of flows and end points of flows in the distributed system. As another example, the network data can include times associated with a portion of the flows. At 84, a statistical model of the network based on the network data to determine a statistical deviation of a flow can be employed (e.g., by statistical model component 22). At 86, a number of statistically deviated flows connected to the flow can be discovered (e.g., by statistically deviated flow component 24). At 88, based on the number of statistically deviated flows connected to the flow, it may be determined if the flow is an anomaly in the distributed system (e.g., by statistically deviated flow component 24).

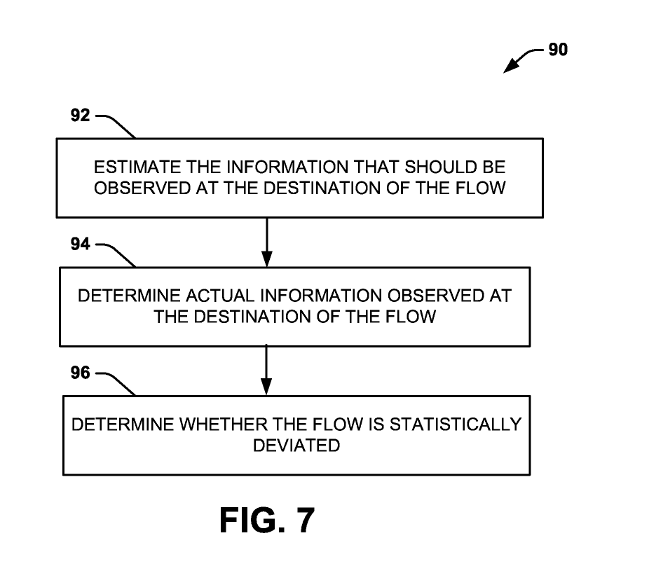

FIG. 7 illustrates a flowchart of another example method 90 for employing a statistical model of the network. For example, the method 90 can be executed by a system (e.g., anomaly detection system 10) that can include a non-transitory memory (e.g., non-transitory memory 12) that stores machine executable instructions and a processing resource (e.g., processing unit 14) to access the memory and execute the instructions to cause a computing device to perform the acts of method 70. For example, method 90 can be performed by a statistical model component 22 of the anomaly detection system 10 of FIG. 1.

At 92, the information that should be observed at the destination of the flow can be estimated. At 94, the actual information that was observed at the destination of the flow can be determined. The missing information during the flow can be inferred. The inference can be completed using the statistically model. For example, the statistical model can use all the available information in the data with assumptions from domain and contextual knowledge of the flow to infer the missing information during the flow. For example, the inference can be in terms of the mean and variance. At 96, whether the flow is statistically deviated can be determined. For example, the observation can be compared to the estimated mean and variance to determine whether a flow is statistically deviated or not.

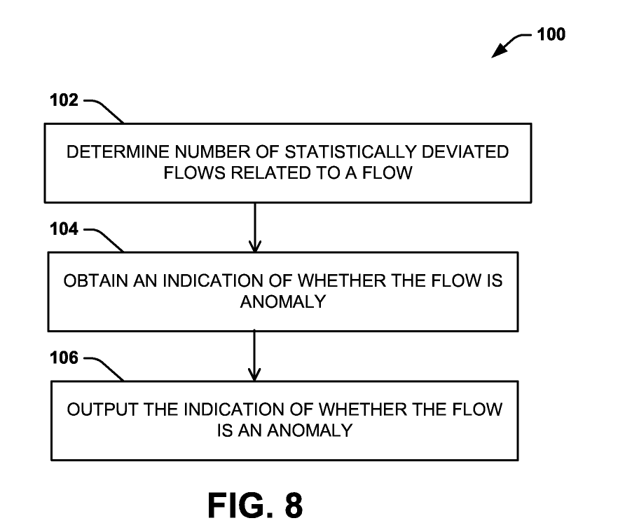

FIG. 8 illustrates a flowchart of an example method 100 for determining if a flow is an anomaly. For example, the method 100 can be executed by a system (e.g., anomaly detection system 10) that can include a non-transitory memory (e.g., non-transitory memory 12) that stores machine executable instructions and a processing resource (e.g., processing unit 14) to access the memory and execute the instructions to cause a computing device to perform the acts of method 100. The method 100 can address the insufficiency of statistical deviations as sole indicators of anomalies.

At 102, a number of statistically deviated flows related to a flow can be determined (e.g., by statistically deviated flow component 24). For example, a plurality of flows connected to a flow can be examined. In other words, in addition to the statistical deviation of each flow, for each flow a number of statistically deviated flows connected to the flow can be derived. The derivation depends on the context and nature of the distributed system. In some examples, a time and a location related to each statistically deviated flow can be determined. For example, the relation can be defined in terms of the time and the physical location of the flow.

At 104, an indication of whether the flow is an anomaly can be obtained (e.g., by statistically deviated flow component 24). For example, an indication of whether the flow is an anomaly can be obtained by positively correlating to the number of statistically deviated flows that are related to the flow. In some examples, the indication of whether the flow is an anomaly is based on the number of statistically deviated flows that are related to the flow. Using the end (source and destination) points of an anomalous flow, the physical location of the anomaly within the distributed system can be isolated.

At 106, the indication of whether the flow is an anomaly can be output (e.g., by output 26). For example, the output can include a location of the anomaly and the strength of the anomaly. As one example, the output can include a plurality of flows with the associated location and strength of the anomaly for each of the plurality of flows. As another example, the output can include a single flow with the associated location and strength of the anomaly for the flow. In either example, the output can be displayed (e.g., by display 16 or on another computing device) so that further actions can be undertaken.

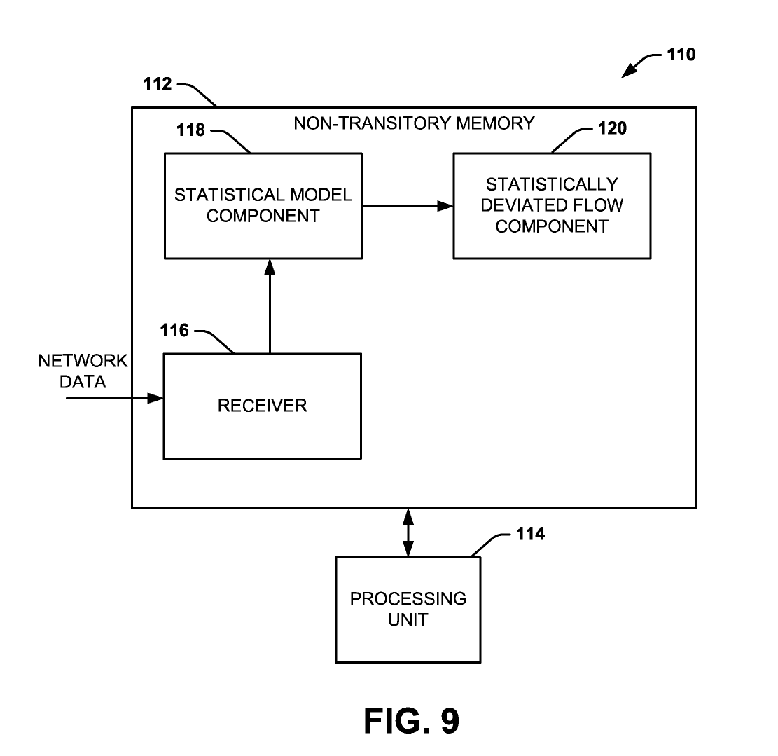

FIG. 9 illustrates an example of an anomaly detection system 110. The anomaly detection system 110 can comprise a non-transitory memory 112 to store machine readable instructions. The anomaly detection system 110 can also comprise a processing unit 114 to access the non-transitory memory 112 and execute the machine readable instructions. The machine readable instructions can comprise a receiver 116 to receive network data related to a distributed system. The machine readable instructions can also comprise a statistical model component 118 to employ a statistical model of the network based on the network data to determine a statistical deviation of a flow. The machine readable instructions may also comprise a statistically deviated flow component 120 to discover a number of statistically deviated flows connected to the flow and to determine if the given flow is an anomaly based on the number of statistically deviated flows connected to the given flow.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A method, comprising:
receiving, by a system comprising a non-transitory memory and a processing resource, network data related to a distributed system;
employing, by the system, a statistical model of the distributed system based on the network data to determine a statistical deviation of a given flow of information through a portion of the distributed system;
determining, by the system, a number of statistically deviated flows connected to the given flow based on a context of the distributed system; and
determining, by the system, if the given flow is an anomaly based on the number of statistically deviated flows connected to the given flow.

2. The method of claim 1, wherein employing the statistical model further comprises inferring missing information during the given flow based on domain knowledge of the given flow and contextual knowledge of the given flow.

3. The method of claim 1, wherein employing the statistical model further comprises estimating information expected to be observed at a destination of the given flow.

4. The method of claim 3, wherein the information comprises at least one of a statistical mean of the information that should be observed at the destination of the given flow or a statistical variance of the information that should be observed at the destination of the given flow.

5. The method of claim 1, wherein discovering the number of statistically deviated flows further comprises determining an elapsed travel time through a start point and an end point related to each statistically deviated flow.

6. The method of claim 1, wherein discovering the number of statistically deviated flows further comprises obtaining an indication of whether the given flow is an anomaly based on the number of statistically deviated flows that are related to the given flow.

7. The method of claim 1, further comprising outputting, by the system, an indication that the given flow is an anomaly.

8. The method of claim 1, wherein the network data comprises source points of flows and end points of flows in the distributed system.

9. The method of claim 8, wherein the network data further comprises time information for at least the source points and the end points of the flows.

10. A non-transitory computer readable medium to store machine readable instructions that when accessed and executed by a processing resource cause a computing device to perform operations, the operations comprising:
receiving network data comprising source points and end points of a plurality of flows that propagate through different nodes distributed throughout a network;
employing a statistical model of the network based on the network data to determine a statistical deviation of a given flow of the plurality of flows in a distributed system;
determining a number of statistically deviated flows from the plurality of flows connected to the given flow;
determining, if the given flow is an anomaly based on the number of statistically deviated flows connected to the given flow, a strength of the anomaly; and
outputting the strength of the anomaly and a location of the anomaly in the distributed system.

11. The non-transitory computer readable medium of claim 10, wherein discovering the number of statistically deviated flows further comprises determining a travel time through a corresponding source point and end point related to each statistically deviated flow.

12. The non-transitory computer readable medium of claim 10, wherein discovering the number of statistically deviated flows further comprises obtaining an indication of whether the given flow is an anomaly based on the number of statistically deviated flows that are related to the given flow.

13. The non-transitory computer readable medium of claim 10, wherein employing the statistical model further comprises estimating a statistical mean expected to be observed at a destination of the given flow or a statistical variance expected to be observed at the destination of the given flow.

14. The non-transitory computer readable medium of claim 10, wherein the network data further comprises time information associated with a portion of the plurality of flows.

15. An anomaly detection system, comprising:
a non-transitory memory to store machine readable instructions; and
a processing resource to access the memory and execute the machine readable instructions, the machine-readable instructions comprising:
a receiver to receive network data comprising source points and end points of a plurality of flows in a distributed system;
a statistical model component to employ a statistical model of the distributed system based on the network data to determine a statistical deviation of a flow of the plurality of flows;
a statistically deviated flow component to discover a number of statistically deviated flows from the plurality of flows connected to the flow based on a time value and a location value related to each statistically deviated flow and determine whether the given flow is an anomaly; and
an output component to output an indication of the anomaly.
